(19) United States
(12) Patent Application Publication
(10) Pub. No.: US 2018/0189872 A1
(43) Pub. Date: Jul. 5, 2018

(54) SYSTEMS AND METHODS FOR GENERATING PERSONALIZED LENDING SCORES

(71) Applicant: MasterCard International Incorporated, Purchase, NY (US)

(72) Inventors: Manash Bhattacharjee, Jersey City, NJ (US); Prashanna S. Tiwaree, New York, NY (US); Prashant Sharma, Madison, NJ (US)

(21) Appl. No.: 15/399,318

(22) Filed: Jan. 5, 2017

(51) Int. Cl. G06Q 40/02; G06Q 30/02

(52) U.S. Cl. CPC G06Q 40/025; G06Q 30/0204

(57) ABSTRACT

A scoring engine computing device for generating personalized lending scores is provided. The scoring engine computing device receives a request including a cardholder identifier associated with a candidate cardholder, determines demographic data associated with the candidate cardholder, and retrieves transaction data for a plurality of cardholders including the candidate cardholder and a set of peer cardholders. Each cardholder of the set of peer cardholders is associated with the determined demographic data of the candidate cardholder, and the transaction data is associated with transactions for a plurality of spending categories. The scoring engine computing device further normalizes the transaction data associated with the candidate cardholder by category, generates a personalized lending score associated with the candidate cardholder that indicates a spending trend of the candidate cardholder, and transmits the personalized lending score to a requestor computing device.

### BACKGROUND

This disclosure relates to personalized lending scores and, more specifically, to generating a personalized lending score for a cardholder within a proper demographic context based on the cardholder's own spending behaviors.

Current lending approval guidelines are based on credit scores, such as FICO scores, that are determined by over-generalizing scoring models. Typical credit scores are meant to characterize overall ‘creditworthiness’ (or loan default risk) of an individual by combining credit report information and representing it in a single number. However, this credit report information only contains previous debt/loan and payment information, and does not include other relevant information needed (such as categorized spending and demographics) to accurately gauge an individual's spending behaviors among their peers and at a granular level. For instance, a FICO score alone does not accurately represent the spending behavior of a 25 year-old individual as compared to a 50 year-old individual. Likewise, a FICO score alone fails to accurately represent the spending behavior of a New York City resident as compared to a St. Louis City resident.

Accordingly, there is a need for evaluating an individual's creditworthiness by considering their spending behavior within the proper demographic context.

### BRIEF DESCRIPTION OF THE DISCLOSURE

In one aspect, a scoring engine computing device is provided. The scoring engine computing device includes a processor in communication with a memory. The processor is programmed to receive a request from a requestor computing device, the request including a cardholder identifier associated with a candidate cardholder, and to determine demographic data associated with the candidate cardholder based at least in part on the request. The processor is also programmed to retrieve transaction data for a plurality of cardholders including the candidate cardholder and a set of peer cardholders. Each cardholder of the set of peer cardholders is associated with the determined demographic data of the candidate cardholder, and the transaction data is associated with transactions for a plurality of spending categories. The processor is further programmed to normalize, for each spending category, the transaction data associated with the candidate cardholder based at least in part on the transaction data associated with the set of peer cardholders, and to generate a personalized lending score associated with the candidate cardholder based at least in part on the normalized transaction data, wherein the personalized lending score indicates a spending trend of the candidate cardholder. The processor is then programmed to transmit the personalized lending score to the requestor computing device.

In another aspect, a method for generating a personalized lending score associated with a candidate cardholder is provided. The method is performed using a scoring engine computing device including a processor in communication with a memory. The method includes receiving a request from a requestor computing device, the request including a cardholder identifier associated with a candidate cardholder, and determining demographic data associated with the candidate cardholder based at least in part on the request. The method also includes retrieving transaction data for a plurality of cardholders including the candidate cardholder and a set of peer cardholders, wherein each cardholder of the set of peer cardholders is associated with the determined demographic data of the candidate cardholder and wherein the transaction data is associated with transactions for a plurality of spending categories, and normalizing, for each spending category, the transaction data associated with the candidate cardholder based at least in part on the transaction data associated with the set of peer cardholders. The method further includes generating a personalized lending score associated with the candidate cardholder based at least in part on the normalized transaction data, wherein the personalized lending score indicates a spending trend of the candidate cardholder, and transmitting the personalized lending score to the requestor computing device.

In yet another aspect, a non-transitory computer-readable storage medium having computer-executable instructions embodied thereon is provided. When executed by a scoring engine (SE) computing device including at least one processor coupled to a memory, the computer-executable instructions cause the SE computing device to receive a request from a requestor computing device, the request including a cardholder identifier associated with a candidate cardholder, and determine demographic data associated with the candidate cardholder based at least in part on the request. The computer-executable instructions also cause the SE computing device to retrieve transaction data for a plurality of cardholders including the candidate cardholder and a set of peer cardholders, wherein each cardholder of the set of peer cardholders is associated with the determined demographic data of the candidate cardholder and wherein the transaction data is associated with transactions for a plurality of spending categories, and normalize, for each spending category, the transaction data associated with the candidate cardholder based at least in part on the transaction data associated with the set of peer cardholders. The computer-executable instructions further cause the SE computing device to generate a personalized lending score associated with the candidate cardholder based at least in part on the normalized transaction data, wherein the personalized lending score indicates a spending trend of the candidate cardholder, and to transmit the personalized lending score to the requestor computing device.

### BRIEF DESCRIPTION OF THE DRAWINGS

FIGS. 1-8 show example embodiments of the methods and systems described herein.

FIG. 1 is a block diagram of a personalized lending score (PLS) system including a scoring engine (SE) computing device.

FIG. 2 is a data flow diagram illustrating the flow of data between various components of the PLS system shown in FIG. 1.

FIG. 3 illustrates an example configuration of a remote device system for use in the system shown in FIG. 1.

FIG. 4 illustrates an example configuration of a server system for use in the system shown in FIG. 1.

FIG. 5 is an example multi-party payment card processing system that may be used to provide transaction data to the system shown in FIG. 1.

FIG. 6 is an example scoring table for a candidate cardholder that may be generated by the system shown in FIG. 1.

FIG. 7 is a flowchart of an example process for providing a personalized lending score using the system shown in FIG. 1.

FIG. 8 is a diagram of components of an example computing device that may be used in the PLS system shown in FIG. 1.

Like numbers in the Figures indicate the same or functionally similar components. Although specific features of various embodiments may be shown in some figures and not in others, this is for convenience only. Any feature of any figure may be referenced and/or claimed in combination with any feature of any other figure.

### DETAILED DESCRIPTION OF THE DISCLOSURE

The personalized lending score (PLS) system described herein is configured to generate personalized lending scores by generating one or more ratings that are representative of a cardholder's spending behaviors within the appropriate demographic context. For example, the PLS system benchmarks transactional data by age group, income group, and/or geo-location, and weights spending behavior by transaction category. The personalized lending scores are provided to one or more banks or other lending parties that analyze the scores to determine whether or not to provide loans to the cardholders corresponding to the personalized lending scores.

Specifically, the systems and methods described herein include an improved scoring model that generates personalized lending scores that more accurately characterize an individual's spending habits. The personalized lending score incorporates transaction category, age group, income group, balance/asset information, social media scores, and/or residence location information as related to an individual and their consumer activity. The advantages of such a unique, personalized lending score include greater lender confidence for approving loans as well as more objective consideration for individuals applying for a loan.

In the example embodiment, the PLS system includes a scoring engine (SE) computing device including and/or in communication with a user computing device. The SE computing device is configured to obtain transaction data for an individual (i.e., a cardholder), identify demographic data that is associated with the cardholder, normalize the transaction data using the demographic data, determine a personalized lending score using the standardized transaction data, and cause the display of the determined score on the user computing device. The SE computing device is a specifically configured computing device that is capable of functioning as described herein, including a dedicated computing device associated solely with the PLS system. The SE computing device includes a processor in communication with a memory.

The PLS system further includes a database in wired and/or wireless communication with the SE computing device. In some embodiments, the database is a centralized database that is integral to the SE computing device, or in alternative embodiments the database is a separate component and external to the SE computing device. The database is accessible to the SE computing device and is configured to store and/or otherwise maintain a variety of information, as described further herein. For example, the database may store spending categories, category ratings, demographic spending data (e.g., geo-location data, age group data, income group data), scoring modules, and/or any other information.

The SE computing device is configured to receive a request for a personalized lending score associated with a cardholder of a payment account. Cardholders can be individuals, families (e.g., account co-owners), businesses, and the like. The request for a personalized lending score is received from a user via a user computing device. In the example embodiment, the user submitting the request is, in some cases, a lender. A lender can be an individual, a public group, a private group, or a financial institution that makes funds available to another with the expectation that the funds are to be repaid. The lender may provide funds for a variety of reasons such as mortgage loans, personal loans, business loans, auto loans, and/or other lines of credit. In some embodiments, the user submitting the request is the cardholder. Included within the request is at least one payment account identifier (such as a primary account number, or PAN) that identifies a payment account such as a credit account, debit account, prepaid account, and/or any other account that contains transaction data associated with the cardholder. The request further includes information (for example demographic information or identifiers relating to residential/billing address, age, income, etc.) associated with the cardholder. In some embodiments, this information makes up part of the payment account identifier.

Responsive to the request, the SE computing device is configured to obtain transaction data associated with the payment account identifier that was included in the request. In the example embodiment, the transaction data includes all completed transactions from the past 3 years. In other embodiments, the transaction data includes all completed transactions from a time range that is predetermined by the SE computing device or as manually selected by the user (e.g., the lender or cardholder). The transaction data indicates an overall spending trend of the cardholder, as well as the cardholder's spending trends for specific categories. For example, spending categories include groceries, high end groceries, low end groceries, fast food restaurants, fine dining restaurants, healthy eating restaurants, travel, entertainment, gambling, adult entertainment, utilities, charity, preventive healthcare, and combinations thereof.

The SE computing device is also configured to retrieve demographic spending data corresponding to the demographic information associated with the cardholder that was included or identified in the request. The demographic spending data includes category ratings and average spending amounts for each relevant demographic group (in which the cardholder falls) in each spending category. For instance, a category rating with a negative value indicates a category associated with an undesirable spending habit (e.g., gambling) and a category rating with a positive value indicates a category associated with a desirable spending habit (e.g., preventive healthcare). In the example embodiment, the net rating of all spending categories is 1. The SE computing device is configured to normalize the cardholder's transaction data using the demographic spending data and generate various scores, modified scores, and expense ratings for each category and, in some embodiments, additionally over a combination of some or all categories. For instance, a score for each category indicates the weight of that particular category when the cardholder's actual spending in that category is evaluated against the average peer spending value. A modified score for each category indicates the weight of that particular category rating as adjusted by the cardholder's actual spending in that category. In the example embodiment, a negative expense rating indicates that the cardholder's spending is dominated by undesirable spending categories and a positive expense rating indicates that the cardholder's spending is dominated by desirable spending categories. Further in the example embodiment, a negative total expense rating indicates that the cardholder spends more than an average peer within the demographic group, while a positive total expense rating indicates that the cardholder saves more than an average peer within the demographic group.

Once the cardholder's transaction data has been normalized and placed within its proper demographic context, the SE computing device is configured to generate a personalized lending score based at least in part on the scores and ratings determined as a result of the normalization process. In the example embodiment, a typical credit score for the cardholder is also included in determining the personalized lending score. The typical credit scores merely represent the cardholder's loan/debt information and related payment behaviors. By incorporating the cardholder's spending behaviors (both categorized and overall), especially within the context of demographically-similar peers, the personalized lending score determined by the SE computing device is a more accurate assessment of the cardholder's ‘creditworthiness’. In some embodiments, the SE computing device is configured to incorporate other data, for example third party data such as other bank account balances and assets and/or social media scores, into the determination of the personalized lending score.

In the example embodiment, the SE computing device is configured to transmit the personalized lending score at least to the user computing device from which the request was received to enable display to the lender. In some embodiments, the scores and ratings generated during the normalization process described above are also transmitted to the user computing device along with the personalized lending score. In some embodiments, the SE computing device is configured to generate a flag and append a notification to the transmission communication that includes the personalized lending score. The notification indicates to the lender that at least one of the normalized scores/ratings has exceeded a threshold for a category associated with an undesirable spending habit.

The PLS system described herein, including the SE computing device, provides an objective, fine-tuned lending score to lenders and cardholders that is based on cardholder spending behaviors in their proper demographic context.

The methods and systems described herein may be implemented using computer programming or engineering techniques including computer software, firmware, hardware, or any combination or subset therefor. At least one of the technical problems addressed by this system includes: (i) unidimensional credit scoring based on limited debt payment information; (ii) lack of relevant spending behavior data; and (iii) less objective loan decision-making processes.

The technical effect of the systems and methods described herein is achieved by performing at least one of the following steps: (i) receiving a request from a requestor computing device, the request including a cardholder identifier associated with a candidate cardholder; (ii) determining demographic data associated with the candidate cardholder based at least in part on the request; (iii) retrieving transaction data for a plurality of cardholders including the candidate cardholder and a set of peer cardholders, wherein each cardholder of the set of peer cardholders is associated with the determined demographic data of the candidate cardholder and wherein the transaction data is associated with transactions for a plurality of spending categories; (iv) normalizing, for each spending category, the transaction data associated with the candidate cardholder based at least in part on the transaction data associated with the set of peer cardholders; (v) generating a personalized lending score associated with the candidate cardholder based at least in part on the normalized transaction data, wherein the personalized lending score indicates a spending trend of the candidate cardholder; and (vi) transmitting the personalized lending score to the requestor computing device, wherein a lending party associated with the requestor computing device approves or declines the candidate cardholder for a loan based at least in part on the transmitted personalized lending score.

The resulting technical effect achieved by the systems and methods described herein is at least one of: (i) enhanced information for cardholder loan approvals; (ii) improved processing speeds by providing the personalized lending scores in substantially real-time; (iii) reduced processing, bandwidth, and storage requirements for the requestor computing devices to analyze a candidate cardholder by performing the service at the SE computing device; (iv) improved granularity of the analysis for the candidate cardholder by classifying transaction data according to demographic context and by rating/weighting spending categories; (v) improved customization of the lending scores by providing customizable predefined ratings; and (vi) improved searching and retrieval of transaction data by storing and classifying the transaction data according to specific protocols.

In one embodiment, a computer program is provided, and the program is embodied on a computer-readable medium. In an example embodiment, the PLS system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the PLS system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing spending patterns in industrial, commercial, and residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

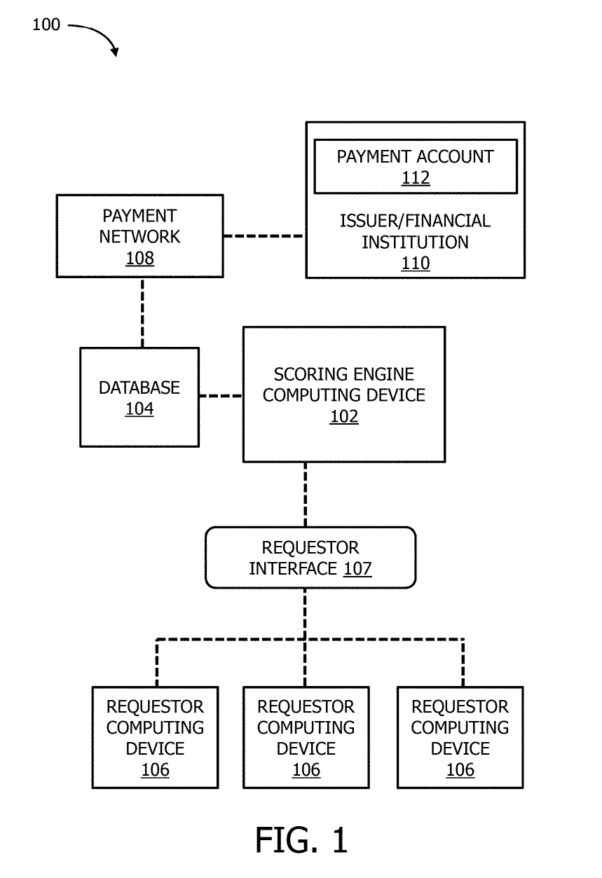

FIG. 1 is a block diagram of a personalized lending score (PLS) system 100 including a scoring engine (SE) computing device 102. SE computing device 102 includes at least one processor in communication with a memory. SE computing device 102 is in communication with a database (memory) 104, requestor computing device(s) 106 via requestor interface 107, and issuer/financial institution 110 via payment network 108 (e.g., a payment processor). Database 104 contains information on a variety of matters, including candidate cardholder transaction data, peer cardholder transaction data, demographic data, predefined spending category ratings, predetermined approval/decline score thresholds, and/or any other information. In some embodiments, database 104 is stored on SE computing device 102. In alternative embodiments, database 104 is stored remotely from SE computing device 102 and may be non-centralized.

In the example embodiment, PLS system 100 further includes a plurality of client subsystems, also referred to as client/user systems or requestor computing devices 106. Each requestor computing device 106 is associated with a lending party (e.g., a bank) or a different third party (e.g., a cardholder/user computing device). Requestor computing devices 106 are communicatively coupled to SE computing device 102 via a requestor interface 107. Requestor interface 107 may be an application program interface (API), a web interface, and/or a different interface that enable requestor computing devices 106 to communicate with SE computing device 102. In one embodiment, requestor computing devices 106 are computers including a web browser, such that SE computing device 102 is accessible to requestor computing devices 106 using the Internet. Requestor interface 107 may include a network, such as a local area network (LAN) and/or a wide area network (WAN), dial-in connections, cable modems, wireless-connections, and special high-speed ISDN lines. Requestor computing devices 106 may be any device capable of interconnecting to the Internet including a mobile computing device, such as a laptop or desktop computer, a web-based phone (e.g., a “smartphone”), a personal digital assistant (PDA), a tablet or phablet, a fitness wearable device, a smart refrigerator or other web-connectable appliance, a “smart watch” or other wearable device, or other web-connectable equipment. Although three requestor computing devices 106 are shown in FIG. 1, it should be understood that PLS system 100 may include any number of requestor computing devices 106.

SE computing device 102 is configured to provide a personalized lending score service to the lending parties of requestor computing devices 106. In particular, SE computing device 102 is configured to receive a score request from requestor computing device 106 that identifies a candidate cardholder and transmits a personalized lending score associated with the candidate cardholder to requestor computing device 106 in response to the request. In at least some embodiments, the personalized lending score is transmitted in near real-time to requestor computing device 106. The personalized lending score is generated based on transaction data associated with the candidate cardholder and other peer cardholders within a determined demographic context as describe herein.

In one embodiment, SE computing device 102 is configured to communicate with a requestor computing device 106 associated with a user (such as a lending party or bank, not shown). Requestor computing device 106 is configured to display an app, for example, at a user interface (not shown) of requestor computing device 106. Lending parties and/or cardholders may access the app to enroll in the personalized lending score service. In some embodiments, the lending parties and/or cardholders are automatically enrolled in the service. In such embodiments, the SE computing device 102 may be configured to enable the lending parties and/or cardholders to opt-out of the service. In certain embodiments, the lending parties and/or cardholders provide enrollment information to SE computing device 102 that facilitates the personalized lending score. The enrollment information may be updated after enrollment. Once enrolled, the lending parties use the personalized lending score service to receive enhanced information associated with a candidate cardholder to determine whether or not to approve a loan for the candidate cardholder. In some embodiments, the app providing access to the personalized lending score service may have inter-app integration functionality, such that the personalized lending score services of the app may be integrated with, for example, budgeting services of another application.

Database 104 is communicatively coupled to SE computing device 102. In other embodiments, database 104 is integrated with SE computing device 102 or payment network 108 (e.g., a payment processor). Database 104 is configured to receive, store, and transmit data for the personalized lending score service. In particular, database 104 may store candidate transaction data, peer transaction data, demographic data, cardholder data, predefined spending category ratings, and predetermined approval/decline score thresholds. The candidate cardholder transaction data and peer cardholder transaction data is associated with a plurality of transactions and is collected during the processing of the transactions by a payment network, such as payment network 108. In the example embodiment, the transaction data is associated with payment accounts 112 (such as payment cards (e.g., credit cards), and/or digital wallets) associated with issuer or financial institution 110. Transaction data may include, but is not limited to, a payment amount, an account identifier (e.g., a primary account number (PAN)), a cardholder identifier, a spending category, and/or a timestamp associated with the transaction. The cardholder data includes, for example, cardholder identifiers (such as PANs) that serve to identify one or more payment accounts 112 associated with a candidate cardholder. Cardholder data may also include other data (e.g., cardholder age, residential address, and income) that provides a demographic context according to which SE computing device 102 can generate a personalized lending score associated with the candidate cardholder. Demographic data may include, for example, age groups, income ranges, and geographical regions that facilitate retrieval of suitable peer cardholder transaction data based on the demographics of the candidate cardholder. Predefined ratings are allocated to each spending category and may, in some embodiments, be dependent the demographic data determined for a candidate cardholder. The predefined category ratings serve to differentiate desirable versus undesirable spending categories, as well as to weight each spending category as more/less desirable or more/less undesirable. Predetermined approval/decline score thresholds include personalized lending score limits according to which an approval/decline recommendation may be made to a lending party with respect to a personalized lending score generated for a candidate cardholder.

In the illustrated embodiment, SE computing device 102 is in communication with a payment network 108. Payment network 108 is configured to process financial transactions thereover. Payment network 108 is in communication with a plurality of issuers/financial institutions 110 (e.g., banks), although only one issuer 110 is shown for clarity. Financial institution 110 maintains one or more payment accounts 112 associated with a cardholder, such as a credit card account, debit account, or prepaid account. In the example embodiment, database 104 receives the transaction data from issuer 110 via payment network 108. Payment network 108 is a closed network (i.e., connection to payment network 108 requires permission from an administrator of the payment network 108). The payment network 108 is configured to facilitate generating, receiving, and/or transmitting messages associated with transactions for one or more merchants, issuers, and acquirers in communication with the payment network 108. In particular, the payment network is configured to facilitate generating, receiving, and/or transmitting messages associated with payment card transactions. The messages are formatted according to specific protocols associated with the network and include extractable data elements that payment network 108 is configured to analyze, extract, and classify to form the transaction data received by SE computing device 102. In one example, at least a portion of the transaction data is extracted from authorization request messages from the payment network 108, such as ISO® 8583 compliant messages and ISO® 20022 compliant messages. Spending categories and/or the cardholder data may also be retrieved from payment network 108. Alternatively, a different computing device provides the spending categories and/or cardholder data to database 104. In one example, the enrollment information provided during enrollment for the personalized lending score service may be stored as cardholder data. In some embodiments, SE computing device 102 is in direct communication with financial institution 110 and retrieves the transaction data directly therefrom, without the intervention of payment network 108.

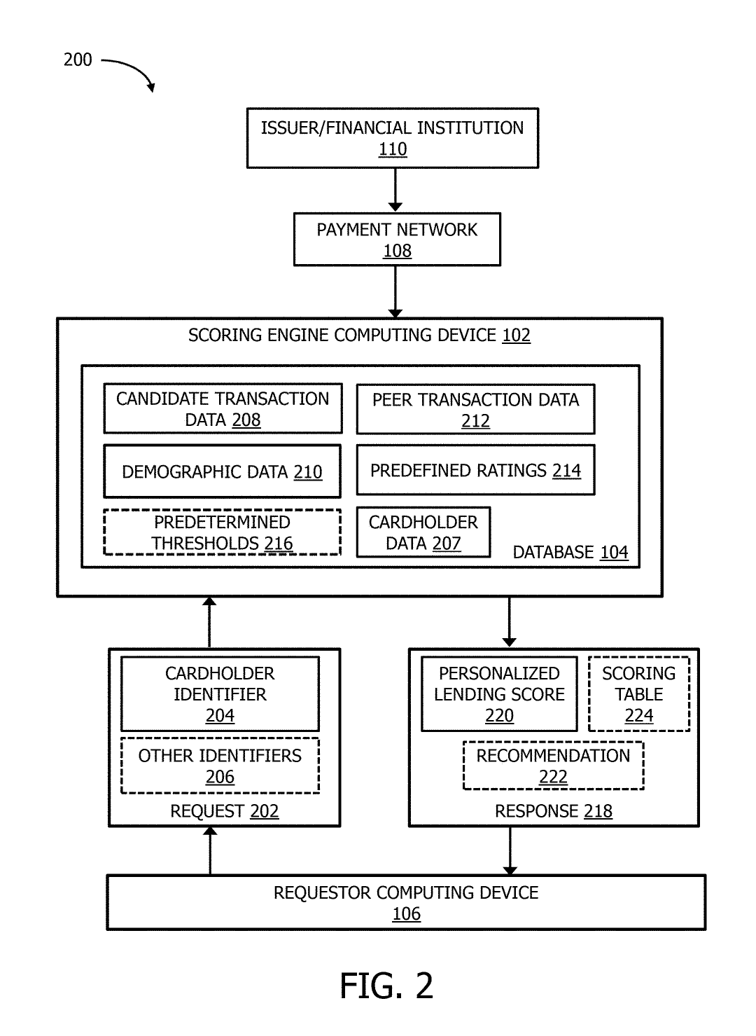

FIG. 2 is a data flow diagram 200 illustrating the flow of data between various components of PLS system 100 (shown in FIG. 1). In particular, FIG. 2 depicts the data flow between requestor computing device 106, SE computing device 102, database 104, and payment network 108. In other embodiments, PLS system 100 may provide additional, fewer, or alternative data, including those described elsewhere herein. As illustrated in FIGS. 1 and 2, database 104 may be a centralized database integral to SE computing device 102, or alternatively, a separate and external component.

With respect to FIGS. 1 and 2, in the example embodiment, requestor computing device 106 transmits a request 202 to SE computing device 102. Score request 202 includes a cardholder identifier 204 associated with a candidate cardholder. SE computing device 102 receives request 202 and determines demographic data associated with the candidate cardholder. In at least some embodiments, request 202 includes other identifiers 206 associated with the candidate cardholder, such as age, location, and/or income identifiers to facilitate the demographic data determination by the SE computing device 102. In other embodiments, SE computing device 102 is configured to perform a lookup in database 104 for the demographic data associated with the candidate cardholder using the cardholder identifier 204. More specifically, SE computing device 102 performs a lookup of cardholder data 207 stored within database 104 using cardholder identifier 204. Cardholder data 207 may also include other information (e.g., cardholder age, residential address, and/or income) that provides a demographic context according to which SE computing device 102 can generate a personalized lending score associated with the candidate cardholder. As part of the determination, SE computing device 102 is configured to identify demographic data (such as age, location, income, etc.) of the candidate cardholder and to further identify the corresponding demographic groups. For instance, SE computing device identifies the age group into which the candidate cardholder age falls, the geographic region into which the residential address of the candidate cardholder falls, and the income range into which the income of the candidate cardholder falls.

In the example embodiment, SE computing device 102 is configured to retrieve candidate transaction data 208 associated with the candidate cardholder and peer transaction data 212 associated with a set of peer cardholders that fall within the same demographic group(s) as the candidate cardholder. The set of peer cardholders may include one or more cardholders. In the example embodiment, transaction data 208 and 212 are received by database 104 from payment network 108.

In the example embodiment, SE computing device 102 normalizes (by spending category) candidate transaction data 208 based on peer transaction data 212 and generates a personalized lending score 220 associated with the candidate cardholder based on the normalized transaction data. More specifically, SE computing device 102 is configured to score each spending category of the candidate transaction data 208 as a function of predefined category ratings 214 and comparison with the respective spending category of the peer transaction data 212. Predefined ratings 214 may be predetermined by the lending party or SE computing device 102. The predefined ratings 214 indicate the desirable/undesirable extent of each spending category within the determined demographic context. In some embodiments, spending categories may further include subcategories. The comparison indicates the spending trend, per category, of the candidate cardholder relative to the peer cardholders. Accordingly, normalizing candidate transaction data 208 by category provides granular scores at a spending category level. The enhanced granularity to analysis of candidate transaction data 208 with respect to peer transaction data 212 allows for certain transactions (i.e., transactions in certain spending categories) to be emphasized compared to other transactions.

Once the candidate transaction data 208 is normalized with respect to peer transaction data 212 for each spending category, the category-based scores are aggregated to generate at least one personalized lending score 220. In the example embodiment, the summation of all category scores provides an expense rating, such that a positive expense rating indicates that the candidate cardholder's spending is dominated by desirable spending categories, whereas a negative expense rating indicates that the candidate cardholder's spending is dominated by undesirable spending habits. Further, a total expense rating may be calculated by taking the difference between the total amount spent for the average peer and the total amount spent for the candidate cardholder, and dividing by the total amount spent for the average peer. Total expense rating indicates the candidate cardholder's spending performance relative to peer transaction data 212 based on total amounts spent over all categories. For instance, a positive total expense rating indicates that the candidate cardholder saves more overall than their average peer, while a negative total expense rating indicates that the candidate cardholder spends more overall than their average peer. The generated personalized lending score 220 may comprise the expense rating and/or the total expense rating for the cardholder candidate. In the example embodiment, SE computing device 102 generates at least one personalized lending score 220 for the cardholder candidate which is then transmitted to requestor computing device 106.

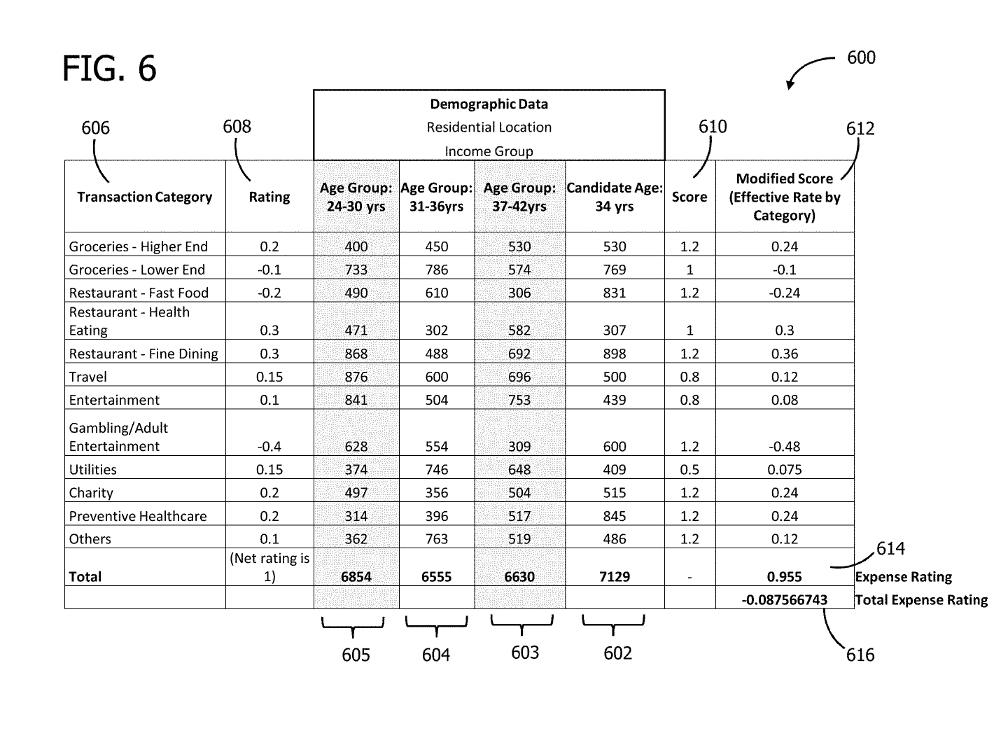

SE computing device 102 is configured to transmit personalized lending score 220 to requestor computing device 106 associated with request 202 for analysis. In the example embodiment, SE computing device 102 generates a response 218 that includes personalized lending score 220 and transmits request response 218 to requestor computing device 106. In at least some embodiments, response 218 may further include individual scores by category and/or a scoring table 224 (such as scoring table 600, further described below with respect to FIG. 6) to requestor computing device 106. Scoring table 224 provides the lending party additional detail about the metrics of the candidate cardholder and its peers as well as the process performed by SE computing device 102 to generate a personalized lending score 220. In particular, scoring table 224 includes spending categories, categorized peer transaction data 212 and candidate transaction data 208, corresponding predefined ratings 214, expense rating and total expense rating. In the example embodiment, SE computing device 102 is configured to transmit request response 218 to requestor computing device 106 in substantially real-time. That is, when requestor computing device 106 transmits request 202 to SE computing device 102, SE computing device 102 provides personalized lending score 220 in near real-time (e.g., within thirty seconds).

In at least some embodiments, SE computing device 102 is configured to generate a recommendation 222 to approve or decline a loan request associated with the candidate cardholder. In particular, the SE computing device 102 stores one or more predetermined thresholds 216. Predetermined thresholds 216 may be determined based on score limits assigned to undesirable spending categories. Personalized lending score 220 is compared to thresholds 216 to generate recommendation 222. In one example, personalized lending score 220 is compared to one threshold 216 and, based on the comparison, SE computing device 102 generates a recommendation 222 to approve or decline the candidate cardholder for a loan request. Recommendation 222 is transmitted to requestor computing device 106 with the personalized lending score 220 to facilitate analysis as described herein.

After requestor computing device 106 receives personalized lending score 220 and any other data from SE computing device 102, the lending party analyzes personalized lending score 220 to determine whether or not to approve or decline a loan request from the candidate cardholder. For example, if the candidate cardholder's spending is dominated by desirable spending categories (i.e., a positive expense rating) and if the candidate cardholder saves more than average with respect to its peers (i.e., a positive total expense rating), the lending party may approve the loan. When comparing loan candidates, the lending party may wish to compare the actual value/magnitude of personalized lending scores and/or individual category scores. In certain embodiments, requestor computing device 106 automatically approves or declines the candidate cardholder for a loan based on personalized lending score 220 and/or recommendation 222. That is, requestor computing device 106 may store a set of instructions or rules for automatically approving or declining loans based on data received from SE computing device 102.

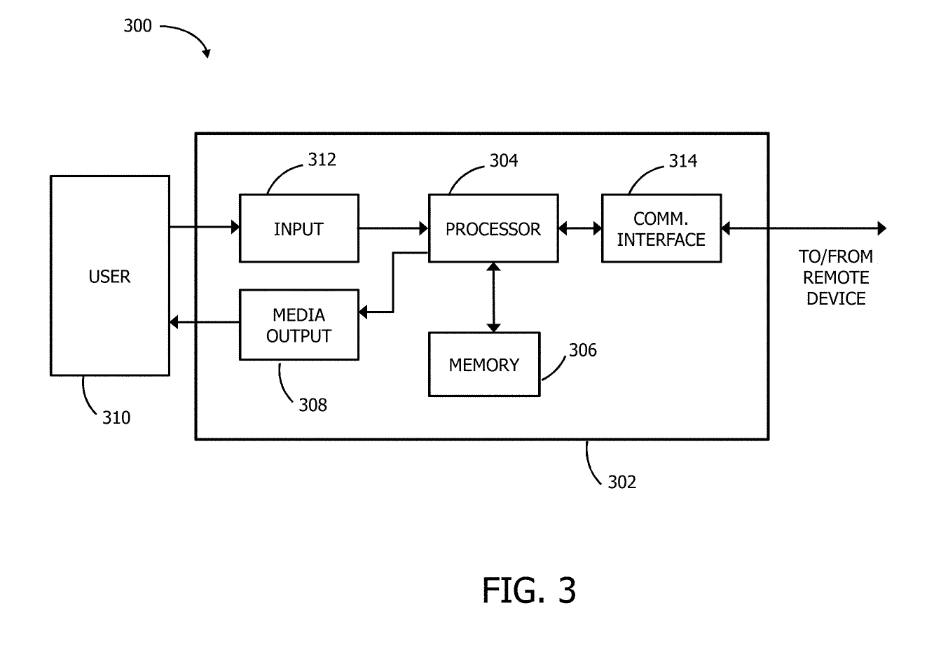

FIG. 3 illustrates an example configuration of a remote device system 300 (such as for use in the system shown in FIG. 1), and depicts an exemplary configuration of a remote or user computing device 302, such as requestor computing device 106 (shown in FIG. 1). Computing device 302 includes a processor 304 for executing instructions. In some embodiments, executable instructions are stored in a memory area 306. Processor 304 may include one or more processing units (e.g., in a multi-core configuration). Memory area 306 is any device allowing information such as executable instructions and/or other data to be stored and retrieved. Memory area 306 may include one or more computer-readable media.

Client computing device 302 also includes at least one media output component 308 for presenting information to a user 310. Media output component 308 is any component capable of conveying information to user 310. In some embodiments, media output component 308 includes an output adapter such as a video adapter and/or an audio adapter. An output adapter is operatively coupled to processor 304 and operatively coupleable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, media output component 308 is configured to present an interactive user interface (e.g., a web browser or client application) to user 310.

In some embodiments, client computing device 302 includes an input device 312 for receiving input from user 310. Input device 312 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 308 and input device 312.

Computing device 302 may also include a communication interface 314, which is communicatively coupleable to a remote device such as SE computing device 102 (shown in FIG. 1). Communication interface 314 may include, for example, a wired or wireless network adapter or a wireless data transceiver for use with a mobile phone network (e.g., Global System for Mobile communications (GSM), 3G, 4G, or Bluetooth) or other mobile data network (e.g., Worldwide Interoperability for Microwave Access (WIMAX)).

Stored in memory area 306 are, for example, computer-readable instructions for providing a user interface to user 310 via media output component 308 and, optionally, receiving and processing input from input device 312. A user interface may include, among other possibilities, a web browser and client application. Web browsers enable users 310 to display and interact with media and other information typically embedded on a web page or a website from a web server associated with a merchant. A client application allows users 310 to interact with a server application associated with, for example, a merchant and/or PLS system 100 (shown in FIG. 1).

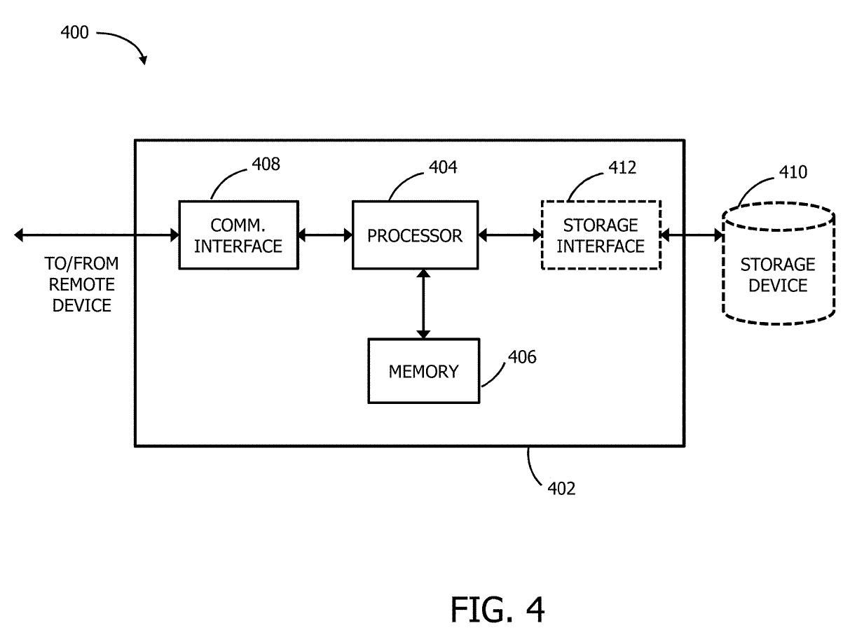

FIG. 4 illustrates an example configuration of a server system 400 (such as for use in the system shown in FIG. 1), and depicts an example configuration of a server computing device 402, such as SE computing device 102 and payment network 108 (shown in FIG. 1). Server computing device 402 includes a processor 404 for executing instructions. Instructions may be stored in a memory area 406, for example. Processor 404 may include one or more processing units (e.g., in a multi-core configuration).

Processor 404 is operatively coupled to a communication interface 408 such that server computing device 402 is capable of communicating with a remote device such as computing device 302 shown in FIG. 3 or another server computing device 402. For example, communication interface 408 may receive requests from requestor computing device 106 via the Internet, as illustrated in FIG. 1.

Processor 404 may also be operatively coupled to a storage device 410. Storage device 410 is any computer-operated hardware suitable for storing and/or retrieving data. In some embodiments, storage device 410 is integrated in server computing device 402. For example, server computing device 402 may include one or more hard disk drives as storage device 410. In other embodiments, storage device 410 is external to server computing device 402 and may be accessed by a plurality of server computing devices 402. For example, storage device 410 may include multiple storage units such as hard disks or solid state disks in a redundant array of inexpensive disks (RAID) configuration. Storage device 410 may include a storage area network (SAN) and/or a network attached storage (NAS) system.

In some embodiments, processor 404 is operatively coupled to storage device 410 via a storage interface 412. Storage interface 412 is any component capable of providing processor 404 with access to storage device 410. Storage interface 412 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 404 with access to storage device 410.

Memory areas 306 (shown in FIG. 3) and 406 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are for example only, and are thus not limiting as to the types of memory usable for storage of a computer program.

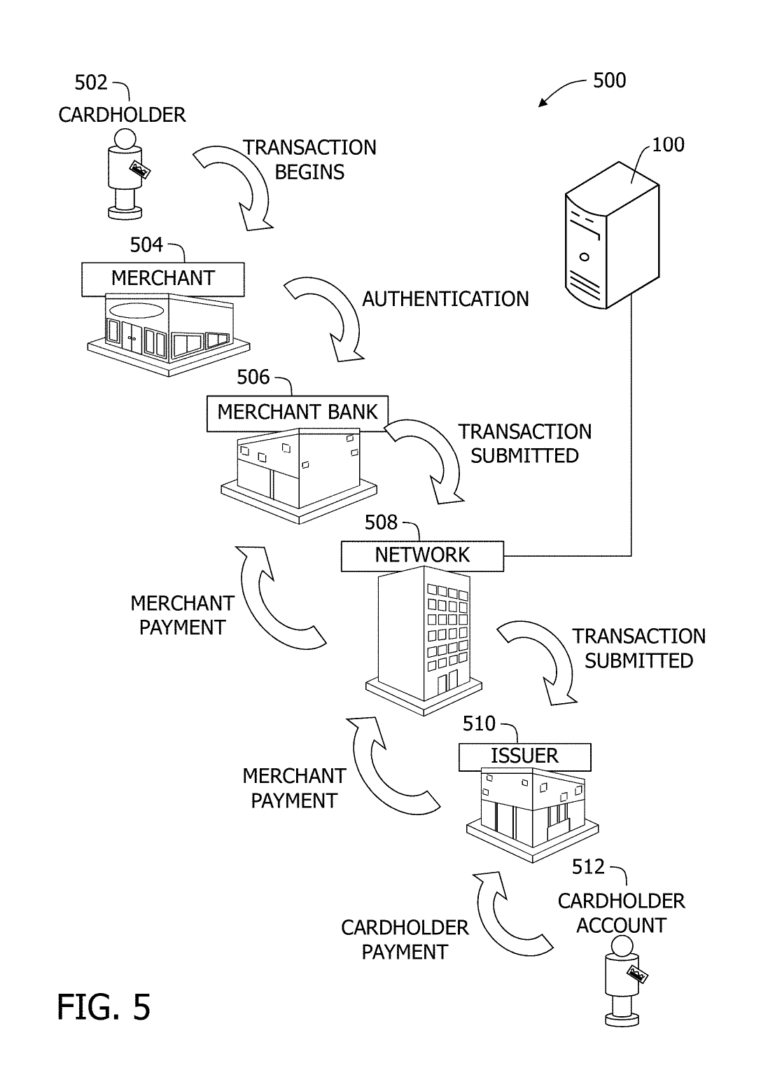

FIG. 5 is a schematic diagram illustrating an example multi-party payment card system 500 for processing payment card transactions. System 500 is communicatively coupled to PLS system 100 (shown in FIG. 1) to provide transaction data, such as authorization messages, to system 100. The present disclosure relates to payment card system 500, such as a credit card payment system using the MasterCard® payment card system payment network 508 (also referred to as an “interchange” or “interchange network”). MasterCard® payment card system payment network 508 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.). In the example embodiment, payment network 108 (shown in FIG. 1) is part of payment network 508.

In payment card system 500, a financial institution such as an issuer 510 issues a payment card for an account, such as a credit card account or a debit card account, to a cardholder 502, who uses the payment card to tender payment for a purchase from a merchant 504. To accept payment with the payment card, merchant 504 must normally establish an account with a financial institution that is part of the financial payment system. This financial institution is usually called the “merchant bank” or the “acquiring bank” or “acquirer bank” or simply “acquirer.” When a cardholder 502 tenders payment for a purchase with a payment card (also known as a financial transaction card), merchant 504 requests authorization from acquirer 506 for the amount of the purchase. Such a request is referred to herein as an authorization request message. The request may be performed over the telephone, but is usually performed through the use of a point-of-interaction terminal, also referred to herein as a point-of-sale device, which reads the cardholder's account information from the magnetic stripe on the payment card and communicates electronically with the transaction processing computers of acquirer 506. Alternatively, acquirer 506 may authorize a third party to perform transaction processing on its behalf. In this case, the point-of-interaction terminal will be configured to communicate with the third party. Such a third party is usually called a “merchant processor” or an “acquiring processor.”

For card-not-present (CNP) transactions, cardholder 502 provides payment information or billing data associated with the payment card electronically to merchant 504. The payment information received by merchant 504 is stored and transmitted to acquirer 506 and/or payment network 508 as part of an authorization request message. In some embodiments, merchant 504 transmits a plurality of authorization request messages together as a “batch” file to acquirer 506 and/or payment network 508.

Using payment card system payment network 508, the computers of acquirer 506 or the merchant processor will communicate with the computers of issuer 510, to determine whether the cardholder's account 512 is in good standing and whether the purchase is covered by the cardholder's available credit line or account balance. Based on these determinations, the request for authorization will be declined or accepted. If the request is accepted, an authorization code is issued to merchant 504.

When a request for authorization is accepted, the available credit line or available balance of cardholder's account 512 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 504 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer, cardholder's account 512 is decreased. Normally, a charge is posted immediately to cardholder's account 512. The bankcard association then transmits the approval to the acquiring processor for distribution of goods/services, or information or cash in the case of an ATM.

After a transaction is captured, the transaction is settled between merchant 504, acquirer 506, and issuer 510. Settlement refers to the transfer of financial data or funds between the merchant's account, acquirer 506, and issuer 510 related to the transaction. Usually, transactions are captured and accumulated into a “batch,” which is settled as a group.

In the example embodiment, payment network 508 is configured to transmit transaction data to PLS system 100 to facilitate generating personalized lending scores based on the transaction data. In some embodiments, PLS system 100 requests or retrieves the transaction data. In other embodiments, payment network 508 transmits the transaction data automatically to PLS system 100. In certain embodiments, the transaction data may be transmitted to PLS system 100 from another source, such as issuer 510.

FIG. 6 is an example scoring table 600 for a candidate cardholder that is generated by a personalized scoring system, such as PLS system 100 (shown in FIG. 1). Table 600 includes candidate transaction data 602 and peer transaction data 604, listed according to dollar amount spent per category 606 per month. The candidate cardholder is 34 years of age and resides in the East Village of New York City, N.Y. As shown in table 600, columns 603 and 605 contain transaction data for cardholders having the same residential location and income range as compared to the candidate cardholder; however the cardholder age groups are outside of the age-related demographic data for the candidate cardholder. Accordingly, transaction data in columns 603 and 605 are not used to generate a personalized lending score 220 for the candidate cardholder, and are illustrated herein to show the improved specificity and relevance provided by PLS system 100 when incorporating multiple levels of demographic data into personalized lending score calculations. In other embodiments, scoring table 600 may include additional, fewer, or alternative data, including data described elsewhere herein. Candidate transaction data 602 is transaction data for a plurality of transactions associated with the candidate cardholder. Peer transaction data 604 is the averaged transaction data for a plurality of transactions associated with peer cardholders of the candidate cardholder. In this example, transaction data was retrieved from the previous 12 months and reported as a monthly average in dollars spent per category. In other embodiments, other time ranges and reported averages for retrieved transaction data may be applied. In the example embodiment, the peer cardholders also reside in the East Village of New York City, N.Y.

In this example, peer transaction data 604 is representative of peer cardholders with an income expected to be within one standard deviation of the candidate cardholder income. In other embodiments, income range may be designated by SE computing device 102 or by the lending party. Each category 606 is given a predefined rating 608 which may be allocated by SE computing device 102 or by the lending party, depending on the embodiment. The predefined ratings characterize and emphasize the desirable or undesirable nature of each spending category. As shown in table 600, for example, a positive (0.2) rating for ‘groceries—high end’ indicates the category is a desirable spending category, while a negative (−0.2) rating for ‘restaurant—fast food’ indicates the category is an undesirable spending category. Further, a larger positive rating indicates the ‘restaurant—health eating’ category (0.3 rating) is a more desirable spending category than the ‘groceries—high end’ category (0.2 rating). Likewise, a larger negative rating indicates the ‘gambling/adult entertainment’ category (−0.4 rating) is a more undesirable spending category than the ‘restaurant—fast food’ category (−0.2 rating). In at least some embodiments, the lending party may customize predefined ratings 608 to facilitate a customized score.

In the example embodiment, candidate transaction data 602 is compared against peer transaction data 604 and given a score 610 for each category. Score 610 is based on the percentage of candidate transaction data 602 as measured against peer transaction data 604. In this example, when candidate transaction data 602 is 110% or above the peer transaction data 604 for the same category, the score 610 is assigned a value of 1.2 (such as for the ‘groceries—higher end’ category). When candidate transaction data 602 is 90-110% of the peer transaction data 604 for the same category, the score 610 is assigned a value of 1 (such as for the ‘groceries—lower end’ category). When candidate transaction data 602 is 70-90% of the peer transaction data 604 for the same category, the score 610 is assigned a value of 0.8 (such as for the ‘travel’ category). When candidate transaction data 602 is 40-70% of the peer transaction data 604 for the same category, the score 610 is assigned a value of 0.5 (such as for the ‘utilities’ category). And when candidate transaction data 602 is 0-40% of the peer transaction data 604 for the same category, the score 610 is assigned a value of 0.3 (not the case for any category in table 600).

Table 600 further includes a modified score 612 for each category 606. Modified score 612 may also be considered as the ‘effective rate’, which is the category rating 608 multiplied by the category score 610. The sum of modified scores 612 over all categories 606 is shown as expense rating 614. In the example shown, expense rating 614 for the candidate cardholder is 0.955. The positive value of expense rating 614 indicates that the candidate cardholder's spending is dominated overall by desirable spending categories. A total expense rating 616 is also given in table 600, and indicates whether the candidate cardholder spends more or saves more across all categories 606 combined (as described above). A positive total expense rating indicates that the candidate cardholder saves more than his average peer cardholder, while a negative total expense rating indicates that the candidate cardholder spends more than his average peer cardholder. In the example of FIG. 6, the candidate cardholder's total expense rating 616 of (approx.) −0.088 shows that the candidate cardholder spends more than his average peer. At least one of the aggregated ratings (i.e., a rating incorporating all categories), such as expense rating 614 and/or total expense rating 616, may be reported to a lending party as the personalized lending score 220 associated with the candidate cardholder. Table 600 provides the additional granular data showing candidate cardholder spending by category, as may be needed for a more in-depth analysis by a lending party. Consequently, loan candidates can be objectively filtered in (or out) based on their actual spending trends and within their proper demographic context. The process performed to generate personalized lending scores 220 facilitates standardizing the spending trends of cardholders across different demographic contexts, thereby enabling a lending party to analyze demographically-unrelated cardholders using the same scoring scale.

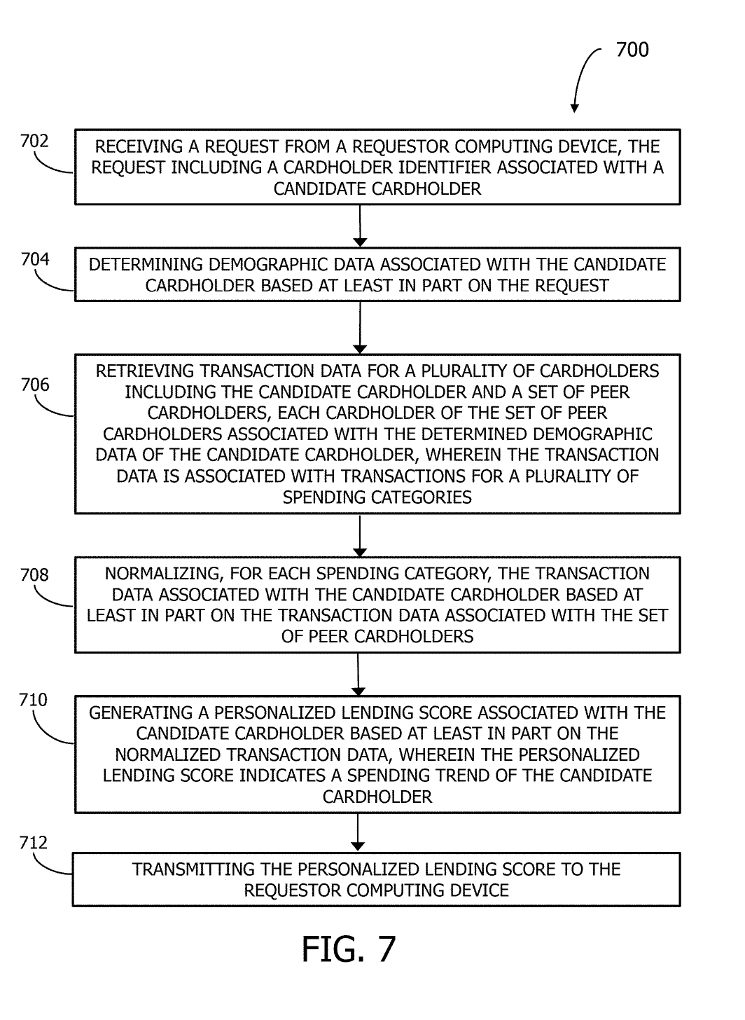

FIG. 7 is a flowchart of a method 700 for providing a personalized lending score associated with a candidate cardholder using a PLS system, such as system 100 (shown in FIG. 1). In the example embodiment, method 700 is performed by an SE computing device, such as SE computing device 102 (shown in FIG. 1). In certain embodiments, method 700 may be at least partially performed by a different computing device. In other embodiments, method 700 may include additional, fewer, or alternative actions, including those described elsewhere herein.

Method 700 begins with the SE computing device receiving 702 a request from a requestor computing device, the request including a cardholder identifier associated with a candidate cardholder. The SE computing device determines 704 demographic data (e.g., an age of the cardholder, an income of the cardholder, a geographical residence location of the cardholder) associated with the candidate cardholder based at least in part on the received request. The SE computing device further retrieves 706 transaction data for a plurality of cardholders including the candidate cardholder and a set of peer cardholders. Demographic data of a set of peer cardholders can be associated with peer transaction data provided by the issuer (e.g., age, residential location, and income may be submitted to the issuer during a card application process to open a cardholder account). In some embodiments, peer cardholder income data can be obtained from third party sources that provide anonymous income data based on the geolocation and/or other demographics of the candidate cardholder. The set of peer cardholders are associated with the same or similar demographic data (e.g., within the same age group, income range, geographical area/region) as the candidate cardholder. The retrieved transaction data is associated with transactions for a plurality of spending categories.

The SE computing device normalizes 708, by spending category, the transaction data associated with the candidate cardholder based at least in part on the transaction data associated with the set of peer cardholders. The SE computing device may also apply predetermined ratings to each spending category of the transaction data to characterize and emphasize desirable spending categories (e.g., charitable giving) versus undesirable spending categories (e.g., gambling and adult entertainment). The SE computing device generates 710 a personalized lending score associated with the candidate cardholder based at least in part on the normalized transaction data, wherein the personalized lending score indicates a spending trend of the candidate cardholder. The SE computing device then transmits 712 the personalized lending score to the requestor computing device to facilitate analysis of the candidate cardholder and to determine whether or not to approve a loan request from the candidate cardholder based on the personalized lending score. In some embodiments, a recommendation may also be generated and transmitted with the personalized lending score to aid a lending party in the approval process.

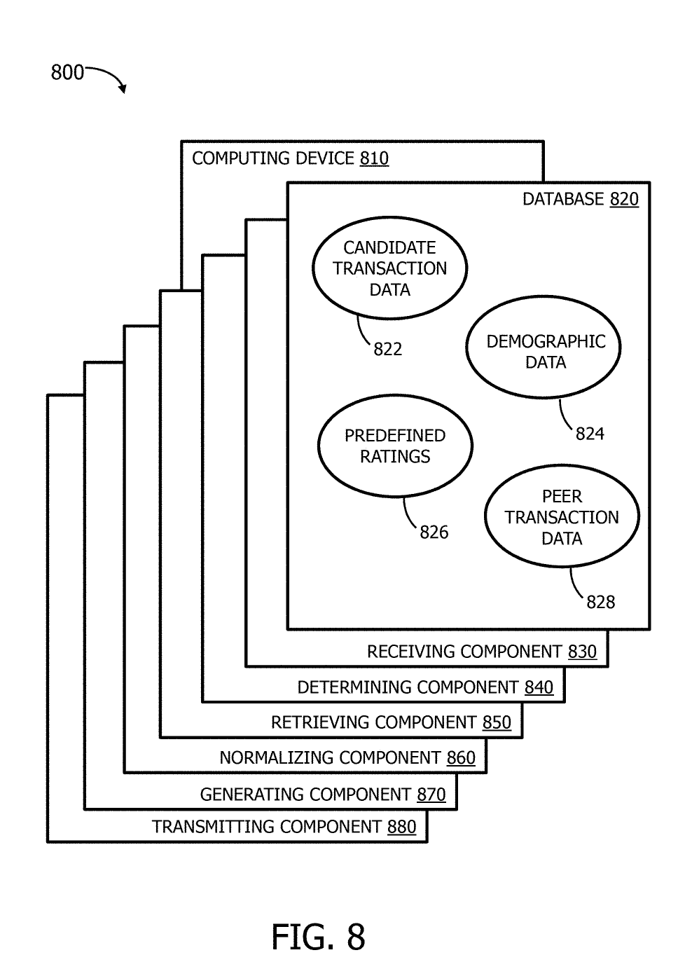

FIG. 8 is a diagram 800 of components of an example computing device 810 that may be used in method 700 shown in FIG. 7. In some embodiments, computing device 810 is similar to SE computing device 102 (shown in FIG. 1). Computing device 810 includes a database 820 configured to store various information. Database 820 may be similar to database 104 (shown in FIG. 1). Database 820 may be coupled with several separate components within computing device 810, which perform specific tasks. In the illustrated embodiment, database 820 is divided into a plurality of sections and stores, including but not limited to, a candidate transaction data section 822 (which may include and/or be similar to candidate transaction data 208, shown in FIG. 2), a demographic data section 824 (which may include and/or be similar to demographic data 210, shown in FIG. 2), a predefined ratings section 826 (which may include and/or be similar to predefined ratings 214, shown in FIG. 2), and a peer transaction data section 828 (which may include and/or be similar to peer transaction data 212, shown in FIG. 2). Database 820 is interconnected to computing device 810 to update and retrieve the information as required.

In the example embodiment, computing device 810 includes a receiving component 830 configured to receive a request associated with a candidate cardholder from a requestor computing device. Computing device 810 further comprises a determining component 840 configured to determine demographic data associated with the candidate cardholder based at least in part on the received request. Computing device 810 further includes a retrieving component 850 configured to retrieve transaction data associated with the candidate cardholder and a set of peer cardholders associated with the determined demographic data. Computing device 810 also comprises a normalizing component 860 configured to normalize, by spending category, the transaction data associated with the candidate cardholder based at least in part on the transaction data associated with the set of peer cardholders. Computing device 810 also includes a generating component 870 configured to generate a personalized lending score associated with the candidate cardholder based at least in part on the normalized transaction data, wherein the personalized lending score is indicative of a spending trend of the candidate cardholder. Computing device 810 additionally includes a transmitting component 880 configured to transmit the generated personalized lending score to the requestor computing device.

Described herein are computer systems such as a payment processor, a requestor computing device, and an SE computing device. As described herein, all such computer systems include a processor and a memory.

Further, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

The term processor, as used herein, refers to central processing units, microprocessors, microcontrollers, reduced instruction set circuits (RISC), application specific integrated circuits (ASIC), logic circuits, and any other circuit or processor capable of executing the functions described herein. The above examples are for example only, and are thus not intended to limit in any way the definition and/or meaning of the term “processor.”

The term database, as used herein, refers to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

As used herein, the terms “software” and “firmware” are interchangeable, and include any computer program stored in memory for execution by a processor (e.g., 304, 404), including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of transaction card can be used as a method of payment for performing a transaction.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

In addition, although various elements of the SE computing device are described herein as including general processing and memory devices, it should be understood that the SE computing device is a specialized computer configured to perform the steps described herein for generating personalized lending scores and loan approval/decline recommendations for a candidate cardholder based on individual and aggregated spending category transaction data of peer cardholders within the candidate cardholder's demographic context.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A scoring engine computing device including a processor in communication with a memory, said processor programmed to:
receive a request from a requestor computing device, the request including a cardholder identifier associated with a candidate cardholder;
determine demographic data associated with the candidate cardholder based at least in part on the request;
retrieve transaction data for a plurality of cardholders including the candidate cardholder and a set of peer cardholders, each cardholder of the set of peer cardholders associated with the determined demographic data of the candidate cardholder, wherein the transaction data is associated with transactions for a plurality of spending categories;
normalize, for each spending category, the transaction data associated with the candidate cardholder based at least in part on the transaction data associated with the set of peer cardholders;
generate a personalized lending score associated with the candidate cardholder based at least in part on the normalized transaction data, wherein the personalized lending score indicates a spending trend of the candidate cardholder; and
transmit the personalized lending score to the requestor computing device.

2. The scoring engine computing device of claim 1, wherein said processor is further programmed to:
apply a plurality of predetermined ratings to the spending categories of the transaction data, wherein a negative rating indicates a spending category associated with an undesirable spending habit and a positive rating indicates a spending category associated with a desirable spending habit; and
generate the personalized lending score based at least in part on the spending category of the transaction data and the predetermined ratings.

3. The scoring engine computing device of claim 2, wherein a net rating for all spending categories is equal to 1.

4. The scoring engine computing device of claim 1, wherein the demographic data includes an age group of the cardholder, an income group of the cardholder, a geographical residence location of the cardholder, and combinations thereof.

5. The scoring engine computing device of claim 1, wherein the generated personalized lending score includes an expense rating wherein a negative expense rating indicates that the candidate cardholder's spending is dominated by undesirable spending categories and a positive expense rating indicates that the candidate cardholder's spending is dominated by desirable spending categories.

6. The scoring engine computing device of claim 1, wherein the generated personalized lending score includes a total expense rating wherein a negative total expense rating indicates that the candidate cardholder generally spends more than a peer cardholder associated with the demographic data, and a positive total expense rating indicates that the candidate cardholder generally saves more than a peer cardholder associated with the demographic data.

7. The scoring engine computing device of claim 1, wherein the plurality of spending categories includes one or more of the following spending categories: groceries, high end groceries, low end groceries, fast food restaurants, fine dining restaurants, healthy eating restaurants, travel, entertainment, gambling, adult entertainment, utilities, charity, preventive healthcare, and combinations thereof.

8. The scoring engine computing device of claim 1, wherein said processor is further programmed to:
generate a recommendation associated with the candidate cardholder by comparing the personalized lending score to at least one predetermined threshold, the recommendation recommending to approve or decline the candidate cardholder for a loan; and
transmit the recommendation with the personalized lending score to the requestor computing device, wherein a lending party associated with the requestor computing device approves or declines the candidate cardholder for the load based at least in part on the recommendation.

9. The scoring engine computing device of claim 1, wherein the personalized lending score is generated based on additional third party information associated with the candidate cardholder including bank account balance, bank account assets, credit report information, credit score, social media score, and combinations thereof.

10. A method for generating a personalized lending score associated with a candidate cardholder, said method performed using a scoring engine computing device including a processor in communication with a memory, said method comprising:
receiving a request from a requestor computing device, the request including a cardholder identifier associated with a candidate cardholder;
determining demographic data associated with the candidate cardholder based at least in part on the request;
retrieving transaction data for a plurality of cardholders including the candidate cardholder and a set of peer cardholders, each cardholder of the set of peer cardholders associated with the determined demographic data of the candidate cardholder, wherein the transaction data is associated with transactions for a plurality of spending categories;
normalizing, for each spending category, the transaction data associated with the candidate cardholder based at least in part on the transaction data associated with the set of peer cardholders;
generating a personalized lending score associated with the candidate cardholder based at least in part on the normalized transaction data, wherein the personalized lending score indicates a spending trend of the candidate cardholder; and
transmitting the personalized lending score to the requestor computing device.

11. The method of claim 10, further comprising:
applying a plurality of predetermined ratings to the spending categories of the transaction data, wherein a negative rating indicates a spending category associated with an undesirable spending habit and a positive rating indicates a spending category associated with a desirable spending habit; and
generating the personalized lending score based at least in part on the spending category of the transaction data and the predetermined ratings.

12. The method of claim 11, wherein a net rating for all spending categories is equal to 1.

13. The method of claim 10, wherein determining the demographic data includes determining an age group of the cardholder, an income group of the cardholder, a geographical residence location of the cardholder, and combinations thereof.

14. The method of claim 10, wherein generating the personalized lending score includes generating an expense rating wherein a negative expense rating indicates that the candidate cardholder's spending is dominated by undesirable spending categories and a positive expense rating indicates that the candidate cardholder's spending is dominated by desirable spending categories.

15. The method of claim 10, wherein generating the personalized lending score includes generating a total expense rating wherein a negative total expense rating indicates that the candidate cardholder generally spends more than a peer cardholder associated with the demographic data, and a positive total expense rating indicates that the candidate cardholder generally saves more than a peer cardholder associated with the demographic data.

16. The method of claim 10, wherein the plurality of spending categories includes one or more of the following spending categories: groceries, high end groceries, low end groceries, fast food restaurants, fine dining restaurants, healthy eating restaurants, travel, entertainment, gambling, adult entertainment, utilities, charity, preventive healthcare, and combinations thereof.

17. The method of claim 10, further comprising:
generating a recommendation associated with the candidate cardholder by comparing the personalized lending score to at least one predetermined threshold, the recommendation recommending to approve or decline the candidate cardholder for a loan; and
transmitting the recommendation with the personalized lending score to the requestor computing device, wherein a lending party associated with the requestor computing device approves or declines the candidate cardholder for the load based at least in part on the recommendation.

18. The method of claim 10, wherein generating the personalized lending score is based on additional third party information associated with the candidate cardholder including bank account balance, bank account assets, credit report information, credit score, social media score, and combinations thereof.

19. A non-transitory computer-readable storage medium having computer-executable instructions embodied thereon, wherein when executed by a scoring engine (SE) computing device including at least one processor coupled to a memory, the computer-executable instructions cause the SE computing device to:
receive a request from a requestor computing device, the request including a cardholder identifier associated with a candidate cardholder;
determine demographic data associated with the candidate cardholder based at least in part on the request;
retrieve transaction data for a plurality of cardholders including the candidate cardholder and a set of peer cardholders, each cardholder of the set of peer cardholders associated with the determined demographic data of the candidate cardholder, wherein the transaction data is associated with transactions for a plurality of spending categories;
normalize, for each spending category, the transaction data associated with the candidate cardholder based at least in part on the transaction data associated with the set of peer cardholders;
generate a personalized lending score associated with the candidate cardholder based at least in part on the normalized transaction data, wherein the personalized lending score indicates a spending trend of the candidate cardholder; and
transmit the personalized lending score to the requestor computing device.

20. The non-transitory computer-readable storage media of claim 19, wherein the computer-executable instructions further cause the SE computing device to:
apply a plurality of predetermined ratings to the spending categories of the transaction data, wherein a negative rating indicates a spending category associated with an undesirable spending habit and a positive rating indicates a spending category associated with a desirable spending habit; and
generate the personalized lending score based at least in part on the spending category of the transaction data and the predetermined ratings.

21. The non-transitory computer-readable storage media of claim 20, wherein a net rating for all spending categories is equal to 1.

22. The non-transitory computer-readable storage media of claim 19, wherein the demographic data includes an age group of the cardholder, an income group of the cardholder, a geographical residence location of the cardholder, and combinations thereof.

23. The non-transitory computer-readable storage media of claim 19, wherein the generated personalized lending score includes an expense rating wherein a negative expense rating indicates that the candidate cardholder's spending is dominated by undesirable spending categories and a positive expense rating indicates that the candidate cardholder's spending is dominated by desirable spending categories.

24. The non-transitory computer-readable storage media of claim 19, wherein the generated personalized lending score includes a total expense rating wherein a negative total expense rating indicates that the candidate cardholder generally spends more than a peer cardholder associated with the demographic data, and a positive total expense rating indicates that the candidate cardholder generally saves more than a peer cardholder associated with the demographic data.

25. The non-transitory computer-readable storage media of claim 19, wherein the plurality of spending categories includes one or more of the following spending categories: groceries, high end groceries, low end groceries, fast food restaurants, fine dining restaurants, healthy eating restaurants, travel, entertainment, gambling, adult entertainment, utilities, charity, preventive healthcare, and combinations thereof.

26. The non-transitory computer-readable storage media of claim 19, wherein the computer-executable instructions further cause the SE computing device to:
generate a recommendation associated with the candidate cardholder by comparing the personalized lending score to at least one predetermined threshold, the recommendation recommending to approve or decline the candidate cardholder for a loan; and
transmit the recommendation with the personalized lending score to the requestor computing device, wherein a lending party associated with the requestor computing device approves or declines the candidate cardholder for the load based at least in part on the recommendation.

27. The non-transitory computer-readable storage media of claim 19, wherein the personalized lending score is generated based on additional third party information associated with the candidate cardholder including bank account balance, bank account assets, credit report information, credit score, social media score, and combinations thereof.
